(19) United States
(12) Patent Application Publication
(10) Pub. No.: US 2013/0106091 A1
(43) Pub. Date: May 2, 2013

(54) SECURITY LAMINATE, METHOD OF MAKING A SECURITY LAMINATE, AND ARTICLE COMPRISING A SECURITY LAMINATE

(71) Applicants: Domenica Kirchmeyer, Grevenbroich (DE); Waldemar Ginter, Ratingen (DE); Bruce D. Orensteen, St. Paul, MN (US)

(72) Inventors: Domenica Kirchmeyer, Grevenbroich (DE); Waldemar Ginter, Ratingen (DE); Bruce D. Orensteen, St. Paul, MN (US)

(21) Appl. No.: 13/521,187

(22) PCT Filed: Jan. 11, 2011
(86) PCT No.: PCT/US11/20743

§ 371 Date: Jan. 16, 2013

(30) Foreign Application Priority Data
Jan. 12, 2010 (EP) 10150578.2

(51) Int. Cl. B42D 15/00

(52) U.S. Cl. CPC B42D 15/00
USPC 283/85; 156/60; 156/277; 156/246

(57) ABSTRACT

The invention provides a security laminate, comprising a protective layer; a volume holographic layer; and a prismatic retroreflective layer, wherein the volume holographic layer is arranged between the protective layer and the prismatic retroreflective layer.

### FIELD OF THE INVENTION

The invention relates to a security laminate for a license plate, a method of making a security laminate, and an article comprising a security laminate.

### BACKGROUND OF THE INVENTION

A variety of security articles are known in the art. For example, U.S. Pat. No. 5,169,707 discloses a retroreflective security article with dual level verification. Included are primary legends that are visible under both ordinary diffuse lighting conditions and under retroreflective lighting conditions, and “retro-legends” that are viewable only under retroreflective viewing conditions. Thus, the primary legend provides a first level of screening or verification under ordinary diffuse lighting conditions, without special equipment. The retro-legends provide a second level of verification under retroreflective lighting conditions, and thus a higher degree of security for the article as a whole.

Another security article is described in U.S. Pat. No. 5,656,360. It includes a holographic layer that is perceptible under normal lighting conditions and substantially imperceptible to the unaided eye under retroreflective lighting conditions, a retroreflective layer perceptible under retroreflective lighting conditions, and means for bonding the retroreflective and holographic layers together.

WO 94/19769 provides a modular and transportable printing system for printing indicia on polymeric sheetings.

### SUMMARY OF THE INVENTION

Although existing security articles may provide for certain advantages there is still a need for a security article which can be used for license plates. Such an article is preferably relatively durable and relatively resistant to temperature variations and chemicals like petrol, and saltwater for example, but on the other hand is desirably relatively inexpensive. Further there is a desire for a security article that can be manufactured on a large scale at a relatively high quality and security level.

A first aspect of the invention provides a security laminate which preferably is adapted for use in a license plate for a vehicle, like a car or a motorcycle, for example. The security laminate comprises a, preferably transparent, protective layer, a volume holographic layer, and a prismatic retroreflective layer. The volume holographic layer is arranged between the protective layer and the prismatic retroreflective layer.

The term “transparent” for the purpose of this specification generally refers to an optical characteristic of a material or an article, which allows for visible light having a wavelength of about 400 nm to about 700 nm to pass through the material or the article without substantial portions of the light being absorbed. A transparent material or article therefore may provide for a preferred transmission for visible light of about 60% to about 100%, more preferably of about 80% to about 100%.

The security laminate as well as any layers comprised in or in relation to the laminate preferably have a front side and an opposite rear side. The front side for the purpose of this specification refers to the side which is intended to face a potential observer. In particular the front side in respect of a license plate is meant to be the side of the license plate that presents the license plate number in a right reading fashion to a viewer.

A security laminate or a license plate as referred to in this specification preferably has a major two-dimensional format laterally to a direction of a potential observer. Further the security laminate or the license plate has a thickness in the direction of the potential observer. The thickness is preferably smaller than any of the dimensions of the format.

A “retroreflective layer” as referred to in this specification preferably is adapted for providing the security laminate or the license plate with retroreflective properties. Such a retroreflective layer preferably provides for reflecting light in about a direction toward the light source substantially independent from an angle the light impinges on the front side of the retroreflective layer.

In a preferred embodiment the prismatic retroreflective layer comprises a plurality of prismatic elements, or the prismatic retroreflective layer may only consist of a plurality of prismatic elements.

Thus the prismatic retroreflective layer may be provided in a form of a continuous prismatic retroreflective sheet comprising the prismatic elements, or in a form of individual prismatic elements. The prismatic elements may be cube-corner elements, or may correspond in shape substantially to cube-corner elements. Such cube corner elements typically have a generally planar front surface, and the rear surface is formed by cube corner. Cube corner elements typically include generally trihedral structures that have three approximately mutually perpendicular lateral faces meeting in a single corner. In use, light incident through the front surface is reflected by each of the three faces of the cube corner elements in a direction substantially toward the source of the light incident on the front surface. The reflection may be provided due to total internal reflection at the lateral faces or by a reflector layer on the lateral faces. According to a further embodiment, a reflective material is provided on the rear side of the prismatic retroreflective layer. The reflective material may be a reflective coating, for example a metallic layer.

Overall therefore the prismatic retroreflective layer preferably has a generally flat or even front side and a prism structured, for example cube-corner structured rear side. The prismatic retroreflective layer is preferably transparent, or made of a transparent material.

In one embodiment a prismatic retroreflective sheet is formed by a support layer which carries the prismatic retroreflective layer. The support layer and the prismatic retroreflective layer may form one piece, for example the support layer may be included in the prismatic retroreflective sheet to provide the sheet with a certain flexural stiffness. This may be achieved for example by providing a layer of a transparent material, and hot forming a prismatic structure in one side of the transparent layer. The prismatic retroreflective layer and the support layer may further be combined from separate pieces to form the prismatic retroreflective sheet. This may be achieved by attaching the prismatic retroreflective layer on the support layer. The prismatic retroreflective layer may for example be casted on the support layer as disclosed in U.S. Pat. No. 5,691,846. Further the prismatic retroreflective layer may be provided in the form of a sheet comprising a preformed prismatic structure which is combined (for example laminated) with the support layer to form the prismatic retroreflective sheet.

Useful materials for making a retroreflective layer are preferably dimensionally stable, durable, weatherable, and readily formable into a desired configuration. Generally any optically transmissive material that is formable, typically under heat and pressure, may be used. The material may further include colorants, dyes, UV absorbers. Separate UV absorbing layers, and other additives may be provided as needed.

Polymers for a cube corner prismatic retroreflective layer may include polycarbonate, polymethylmethacrylate, polyethylene terephthalate, aliphatic polyurethanes, as well as ethylene copolymers and ionomers thereof. Radiation-hardenable polymers may include cross-linked acrylates such as multifunctional acrylates or epoxies and acrylated urethanes blended with mono- and multifunctional monomers. Further, cube corner elements may be cast on to plasticized polyvinyl chloride film. Examples of cube corner-based retroreflective layers are disclosed in U.S. Pat. No. 4,588,258, U.S. Pat. No. 4,775,219, U.S. Pat. No. 4,895,428, and U.S. Pat. No. 5,450,235, for example.

In one embodiment, the volume holographic layer is transparent or translucent. In particular the volume holographic layer may not comprise any metal. The volume holographic layer may have a recording layer that has a thickness that is greater (preferably much greater) than the light wavelength used for recording.

Preferably, the volume holographic layer is provided with an image that is recorded by using an object beam and a reference beam which are angled between about 90 degrees to 180 degrees relative to one another. The volume holographic layer may further comprise an outside adhesive layer. Preferably the volume hologram exhibits characteristic optical properties that are perceptible under diffuse light conditions. In particular the volume hologram may exhibit an optically visible image appearing at different colors when observed from different angles.

In one embodiment the volume holographic layer faces with its front side to the protective layer and with its rear side to the prismatic retroreflective layer. The volume holographic layer may be bonded to the protective layer. For example an adhesive layer may be present between the protective layer and the volume holographic layer to bond the layers together.

In one embodiment the protective layer forms the support layer, whereas in an alternative embodiment the security laminate comprises the protective layer and an additional support layer. The prismatic retroreflective layer may be arranged at least partially directly on the support layer, for example on the protective layer or on the additional support layer. Further the volume holographic layer may be arranged between the support layer and the prismatic retroreflective layer. In this embodiment the prismatic retroreflective layer may be partially or entirely arranged directly on the volume holographic layer. In the embodiment having an additional support layer the volume holographic layer may be further arranged between the support layer and the protective layer.

In one embodiment the volume holographic layer may form a continuous holographic sheet. Such a holographic sheet may have a format that generally corresponds to a format of at least one further layer of the security laminate. This may for example provide for a license plate in which the format of the volume holographic layer substantially corresponds to the format of the license plate. In further embodiments the volume holographic layer forms a continuous stripe or a non-continuous patch. A holographic stripe may for example have a format that is only in one dimension smaller than the format of at least one further layer of the security laminate or the license plate. A holographic patch further may have a format that in both dimensions is smaller than the format of at least one further layer of the security laminate or the license plate.

In another embodiment the volume holographic layer may be comprised in a continuous partial holographic sheet, a partial holographic stripe, or a partial holographic patch. Such a partial holographic sheet, stripe or patch may have a first portion comprising the transparent holographic layer and a second portion which is free of a transparent holographic layer. The second portion may be generally transparent, for example. The first and second portions may form one piece. Thus the volume holographic layer may comprise at least one hologram. The volume holographic layer may further comprise a plurality of separate holograms, for example arranged (preferably equally) spaced from each other and located across the area of the layer. This may ensure that after applying indicia onto the security laminate, at least some of the holograms are visible in the spaces between the indicia.

According to one embodiment, a sealing layer is provided on the rear side of the retroreflective layer. The sealing layer may be attached to the prismatic elements such that a plurality of closed hollow spaces is formed between the prismatic elements and the sealing layer. Therefore undesired substances, for example dirt or moisture, may be hindered in reaching the rear side of the prismatic retroreflective layer, and thus the durability of the retroreflective characteristics of the security laminate may be maximized.

In another embodiment, the security laminate is adapted such that to the unaided eye of an observer the volume holographic layer is perceptible through the protective layer under diffuse lighting conditions, and less perceptible under directed light through the protective layer onto the prismatic retroreflective layer.

The security laminate further may comprise an adhesive layer and a releasable liner. The adhesive layer is preferably arranged at the rear side of the security laminate. The adhesive layer may allow for attaching the laminate to a desired location. For example a license plate obtained from the security laminate may be adhered to a vehicle via the adhesive layer. The adhesive layer is preferably covered by the releasable liner to prevent the adhesive layer from impurities or the like prior to use and from prematurely adhering to a substrate.

In another embodiment the security laminate comprises a pattern layer. The pattern layer may be arranged between the prismatic retroreflective layer and the protective layer, or at the front or rear side of any of the layers forming the security laminate. Such a pattern layer may comprise indicia, for example letters, and/or numbers, and/or logos. Such indicia or logos may be printed with colored inks, pearlescent inks, or inks visible under ultraviolet light or imaged using toners or dyes in a pattern.

The protective layer may protect the volume holographic layer and the prismatic retroreflective layer of the security laminate such that the laminate will retain its holographic and retroreflective features during use. The protective layer, which may be colorless or tinted as desired, may comprise a single layer or may comprise more than one layer. It is preferred that the protective layer be transparent or translucent so as to facilitate any underlying information and permit clear inspection of the hologram(s). The protective layer is preferably made of a material which adheres firmly to the volume holographic layer as well as to the retroreflective layer, either due to its inherent properties or with adhesion promoting treatments such as priming or corona treatment. The protective layer is preferably selected to exhibit high resistance to conditions to which the resultant laminate is likely to be subjected, such as abrasion, exposure to deleterious agents, dirt etc. Thus, the protective layer may comprise a durable, tough material. Depending in part upon the application for which the security laminate is being prepared, films of many different polymers and copolymers may be used. Illustrative examples of preferred abrasion-resistant materials for use include high molecular weight thermoplastic copolymers which are inherently tough, of which ionomeric ethylene methacrylic acid copolymers are preferred examples. Other useful examples include ethylene acrylic acid copolymers, polycarbonate, polymethylmethacrylate, polyethylene terephthalate, aliphatic polyurethanes, ethylene copolymers and ionomers thereof, and plasticized polyvinyl chloride film. By “abrasion-resistant” it is meant that the outer layer is resistant to damage such as a substantial reduction in optical clarity or transparency when subjected to abrasive forces.

The contact between the prismatic retroreflective layer and the holographic layer preferably provides for an optically visible pattern which may provide for a combinatory optical effect with the hologram. This is because the hologram picture and the visible prismatic structure may superpose.

It is to be understood that the additional layers described above are not necessarily present in combination only but that also all sub-combinations of such layer is encompassed by the invention.

A second aspect of the invention provides an article comprising a security laminate according to the invention and readable indicia. Indicia may be located on any of the front side or the rear side of the protective layer, the support layer, the prismatic retroreflective layer, or additional layers present in or at the security laminate. The indicia may be printed onto the protective layer. The indicia may be printed, for example, with a thermal printer, such as a wax or resin based thermal transfer ribbon printer. The skilled person will appreciate other printing technologies like screen printing, inkjet printing, or rotogravure for example.

In one embodiment, the article is a license plate. In another embodiment the security laminate comprises only translucent and/or transparent layers. Thus the security laminate may be overall transparent or translucent. Therefore the license plate may be adapted for back lighting, for example may be illuminated from the rear side. For the lighting an LED, OLED or a fluorescent lamp may be used as a light source for example. The light source may further be arranged such that it can illuminate a light guide comprising light scattering particles, and the light guide may be arranged relative to the license plate such that it can back illuminate the license plate.

In another embodiment the license plate comprises a (preferably durable) backing layer connected directly or indirectly to the rear side of the prismatic retroreflective layer. The backing layer may for example comprise aluminum, and may have a thickness of between about 2.2 millimeters and about 3.2 millimeters. The backing layer may further comprise acrylonitrile butadiene styrene (ABS) having a thickness of between about 2.5 millimeters and about 3.8 millimeters.

Alternatively, the article generally may be a security or authentication product, for example a driver's license, an identification card, a vignette, or a certificate.

In one exemplary embodiment the article comprises a radio frequency identification (RFID) element or tag. The RFID element may be used for storing an identification code, for example an identification code which is correlated to indicia present on the license plate.

A third aspect of the invention provides a method of making a security laminate comprising the steps of: a) providing a protective layer and a retroreflective layer; b) applying a volume holographic layer onto the protective layer to form a security protective layer; c) combining the security protective layer and the retroreflective layer to form a security laminate. In one embodiment, an adhesive may be arranged on the volume holographic layer, the protective layer or the reflective layer to increase the adhesion between the volume holographic layer and the layer to which it will be adhered. Other suitable means for providing relatively good adhesion, for example arranging a primer or treating the surface with a Corona treatment, are conceivable as well.

According to a preferred embodiment of the method, the retroreflective layer is a prismatic retroreflective layer.

In one embodiment the method comprises the step of applying the security protective layer to preformed prismatic elements to form the security laminate.

In one embodiment, an adhesive may be arranged on the volume holographic layer, the protective layer or the prismatic retroreflective layer. Thus the adhesion between the volume holographic layer and the layer to which it will be adhered may be maximized.

In one embodiment the volume holographic layer is applied onto the protective layer by hot-stamping or using a layer of pressure sensitive adhesive.

In one embodiment, the volume holographic layer is applied with its front side onto the protective layer.

In another embodiment the method comprises the steps of providing a support layer, and casting the prismatic retroreflective layer onto the support layer. The support layer may be formed by a separate layer, by the protective layer, or the security protective layer.

The step of casting may comprise the steps of:
providing a hardenable resin composition onto the support layer;
contacting the resin composition with a patterned tool; and
hardening the resin composition.

Once the resin is hardened the tool may be removed.

Further embodiments of the method of the invention comprise at least one of the steps of:
using the security laminate to form a license plate;
applying indicia onto the security laminate or the license plate;
providing a pressure sensitive adhesive between the volume holographic layer and the protective layer or the retroreflective layer.

In a further embodiment the method comprises the step of arranging a primer, or Corona treating a surface of at least one of the protective layer, the volume holographic layer, the prismatic retroreflective layer, and (if present) the support layer. Thus an adhesion between combined layers may be maximized.

In another embodiment of the method of the invention the retroreflective layer is a microsphere-type retroreflective layer.

A microsphere-type layer, sometimes referred to as “beaded sheeting”, is well known in the art and includes a multitude of microspheres, for example glass or ceramic microspheres, typically at least partially embedded in a binder layer, and associated with specular or diffuse reflecting material. The reflective material should be provided functionally behind the microspheres. By “functionally behind” is meant that the reflective material is provided behind the microspheres in such a way that in conjunction with the microspheres light will be retroreflected. Typically, this means that the reflective material is directly provided on the microspheres or is slightly spaced away, through a space coat, from the microspheres to adjust to the focal point of the microspheres. Illustrative examples of microsphere-based sheeting are disclosed in U.S. Pat. No. 4,025,159, U.S. Pat. No. 4,983,436, and U.S. Pat. No. 5,262,225.

The reflective material in one embodiment of this invention can be a reflective layer, for example a metal layer. A dielectric mirror may also be provided as the reflective layer or in combination with a metal layer. The dielectric mirrors may be similar to known dielectric mirrors disclosed in U.S. Pat. No. 3,700,305 and U.S. Pat. No. 4,763,985.

In using dielectric mirrors with microspheres, the microspheres typically have a refractive index n2 and have a layer of transparent material disposed thereon which has a refractive index n1. The opposite face of the transparent material having refractive index n1, is in contact with a material having a refractive index n3. Both n2 and n3 have a refractive index of at least 0.1, preferably at least 0.3, higher or lower than n1. The transparent material is a layer typically having an optical thickness corresponding to odd numbered multiples (that is, 1, 3, 5, 7 . . . ) of about one-quarter wavelength of light in the wavelength range of about 380 to about 1,000 nanometers. Thus, either n2>n1<n3 or n2<n1>n3, and the materials on either side of the transparent layer may be either both higher or both lower in refractive index than n1. When n1, is higher than both n2 and n3, n1 is preferably in the 1.7 to 4.9 range, and n2 and n3 are preferably in the 1.2 to 1.7 range. Conversely, when n1 is lower than both n2 and n3, n1 is preferably in the 1.2 to 1.7 range, and n2 and n3 are preferably in the 1.7 to 4.9 range. The dielectric mirror preferably comprises a contiguous array of materials, at least one being in layer form, having an alternating sequence of refractive indices. In a preferred embodiment the contiguous array has from two to seven layers, preferably three to five layers. Desirably all are light transparent materials and are clear or essentially colorless to minimize light absorption. Among the many compounds that may be used in providing transparent materials within the desired refractive index range are: high index materials such as CdS, CeO2, CsI, GaAs, Ge, InAs, InP, InSb, ZrO2, Bi2O3, ZnSe, ZnS, WO3, PbS, PbSe, PbTe, RbI, Si, Ta2O5, Te, TiO2; low index materials such as Al2O3, AlF3, CaF2, CeF3, LiF, MgF2, NaCl, Na3AlF6, ThOF2, elastomeric copolymers of perfluoropropylene and vinylidene fluoride et cetera. Other materials are reported in Thin Film Phenomena, K. L. Chopra, page 750, McGraw-Hill Book Company, New York, (1969). Preferred succeeding layers contain cryolite (Na3 AIF6) and zinc sulfide.

Dielectric mirrors or similar multi-layer reflective coatings can also be used in combination with cube corner sheeting as disclosed in e.g. JP 06-347622 (Ochi), U.S. Pat. No. 6,172,810 (Fleming), U.S. Pat. No. 6,224,219 (Fleming), U.S. Pat. No. 6,243,201 (Fleming) and U.S. Pat. No. 6,350,034 (Fleming).

In a particular embodiment, a semi-transparent retroreflective sheeting is used having a retroreflective side and an opposite rear side, the retroreflective sheeting having a regular or irregular two-dimensional pattern of transparent and opaque areas, the retroreflective material comprising a layer of transparent microspheres and a reflective layer located functionally behind said layer of transparent microspheres, the reflective layer comprising a regular or irregular two-dimensional pattern of metal areas of contiguous metal and open areas having substantially no metal, wherein open areas of the reflective layer correspond to transparent areas of the retroreflective sheeting and metal areas of the reflective layer correspond to opaque areas of the retroreflective material. The transparent microspheres are present in, the transparent and opaque areas and the transparent areas comprise at least 5% of the total surface of the retroreflective sheeting on the retroreflective side. A semi-transparent retroreflective sheeting of this kind is disclosed in GB 2 433 637.

### BRIEF DESCRIPTION OF THE FIGURES

FIG. 1 is a cross-sectional view of a security laminate according to a an embodiment of the invention;

FIG. 2 is a cross-sectional view of a security laminate according to a further embodiment of the invention; and

FIG. 3 is a cross-sectional view of a security laminate according to another embodiment of the invention.

### DETAILED DESCRIPTION OF THE INVENTION

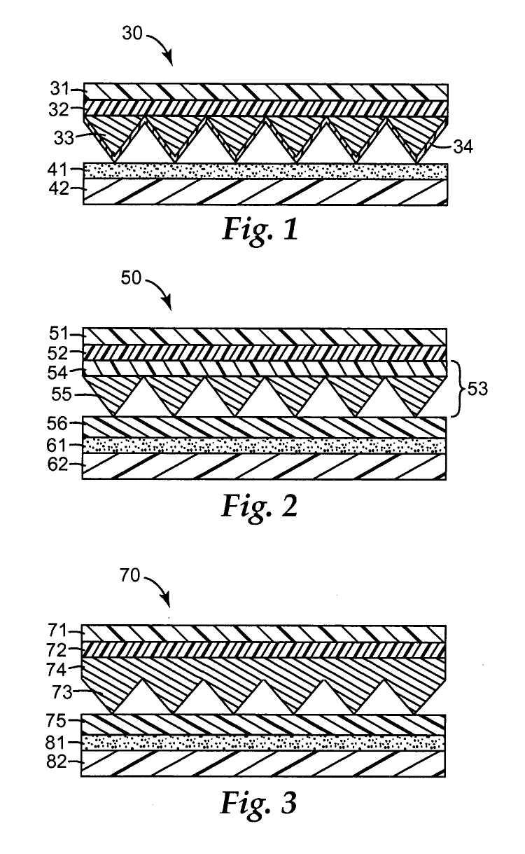

FIG. 1 shows a security laminate 30 comprising a transparent protective layer 31, a volume holographic layer 32, and a prismatic layer 33. The volume holographic layer 32 is arranged between the protective layer 31 and the prismatic layer 33. The security laminate 30 further comprises a releasable liner 42 which is adhered to the prismatic retroreflective layer 33 via an adhesive layer 41.

The example further shows an optional reflector layer 34 which is arranged on the rear side of the retroreflective layer 33. The reflector layer preferably has a good adhesion to the prismatic elements of the prismatic retroreflective layer 33. The reflector layer 34 may be formed, for example, by metal vapor deposition. Aluminum, silver, or the like may be used. Further a primer material may be used, like for example a titanium metal sputtered on the prismatic retroreflective layer 33. Thereby the adhesion of the vapor deposition may be maximized. Alternatively, the reflector layer 34 can comprise a multilayer reflective coating disposed on cube corner elements, such as is described, for example, in U.S. Pat. No. 6,243,201. The thickness of reflector layer 34 is preferable between about 300 to about 800 Angstroms.

FIG. 2 shows a security laminate 50 according to another embodiment. The security laminate 50 comprises a transparent protective layer 51, a transparent volume holographic layer 52, and a prismatic retroreflective layer 55 in combination with a support layer 54. The prismatic retroreflective layer 55 is attached with its front side to the support layer 54. Thus a prismatic retroreflective sheet 53 is formed.

The volume holographic layer 52 is arranged between the support layer 54 and the transparent protective layer 51. In this embodiment, the rear side of the holographic layer 52 is in direct contact with the upper surface of the support layer 54 of the prismatic retroreflective sheet 53.

The prismatic retroreflective sheet 53 provides the security laminate 50 with retroreflective characteristics based on total internal reflection. Therefore a sealing layer 56 is attached to the prismatic elements of the prismatic retroreflective layer 54. The sealing layer 56 is attached to the rear side of the prismatic elements of the prismatic retroreflective layer 55. For example an adhesive may be used for attaching the sealing layer 56 to the retroreflective layer 55. Further the sealing layer 56 may be attached to the retroreflective layer 55 by heat bonding, or by any other suitable method. In the embodiment shown in FIG. 2, the security laminate 50 also comprises an additional releasable liner 62 adhered to the rear side of the sealing layer 56 via an adhesive layer 61.

FIG. 3 shows a security laminate 70 according to another embodiment. The security laminate 70 comprises a transparent protective layer 71, a transparent volume holographic layer 72, a prismatic retroreflective layer 73, and a support layer 74. The support layer 74 is integral with the prismatic retroreflective layer 73. The support layer 74 is arranged opposite of the tips of the prismatic elements of the prismatic retroreflective layer 73. The holographic layer 72 is arranged between the transparent protective layer 71 and the support layer 74. In this embodiment, the rear side of the volume holographic layer 72 is in direct contact with the front side of the support layer 74 of the prismatic retroreflective layer 73.

Furthermore, a sealing layer 75 is attached to the tips of the prismatic elements of the prismatic retroreflective layer 73. Free spaces are provided between the prismatic elements of the prismatic retroreflective layer 73 and the sealing layer 75. The sealing layer 75 preferably provides for the spaces to be kept free of any undesired substances, like for example dirt, dust, and water. The sealing layer 75 is attached to the rear side of the prismatic elements of the prismatic retroreflective layer 73 for example by means of adhesive, heat bonding or any other suitable means. In the embodiment shown in FIG. 3, the security laminate 70 further comprises an adhesive layer 81 at the rear side of the sealing layer 75, and an additional releasable liner 82 covering the adhesive layer 81 at the rear side thereof.

### Example

Although an example is described below to explain the present disclosure in further detail, the present disclosure is not limited by this example.

### Example 1

A 6 in (15.24 cm) by 12 in (30.48 cm) rectangular sample of a retroreflective sheeting with an adhesive layer commercially available from 3M Company, Minnesota, USA, under the trade designation “SCOTCHLITE™ Diamond Grade Series 985” was provided. The width of the rectangular sample was oriented with the machine direction of the retroreflective sheeting. A retroreflective article was provided by laminating the retroreflective sheeting to a 6 in (15.24 cm) by 12 in (30.48 cm) aluminum substrate commercially available from Jupiter Aluminum Corporation, of Illinois, USA, using a powered squeeze roll applicator commercially available from Chemsultants International of Illinois, USA. A volume hologram film was provided, with a repeating legend “3M”. The hologram legend had a three dimensional appearance, and varied in color from orange to green depending on the relative angles of the illumination source and the viewer. A transfer adhesive commercially available from 3M Company, Minnesota, USA, under the trade designation “3M™ Double-linered Laminating Adhesive 9172 MP” was provided. A 1.0 cm by 1.5 cm piece of the transfer adhesive was cut using a razor blade, and the paper liner was removed by hand. The transfer adhesive with the remaining polyethylene liner was applied to the surface of the volume hologram over a holographic letter “M” and pressed down firmly by hand. The section of the hologram onto which the transfer adhesive was applied was cut out and removed from the remaining hologram. The polyethylene liner was removed, leaving a 1.0 cm by 1.5 cm piece of hologram with bare transfer adhesive attached. The adhesive side of the hologram with transfer adhesive attached was applied by hand onto the surface of the retroreflective sheeting on the retroreflective article described above. A 7.5 cm by 8.0 cm piece of transparent protective overlaminate, commercially available from 3M Company, Minnesota, USA, under the trade designation “3M™ Clear Protective Film Series 9097” was provided. The overlaminate was applied over the volume hologram on the retroreflective article, using the powered squeeze roll applicator above. The overlaminate was centered over the volume hologram. The finished retroreflective article with protected volume hologram was treated in an oven at 66 degrees Celsius for 40 minutes to allow trapped air to flow out from beneath the adhesive layers. The finished retroreflective article with protected volume hologram was viewed a various angles under ordinary fluorescent office lighting fixtures. The volume hologram “M” appeared to be three dimensional, and at various angles appeared bright orange or bright green in color. The finished retroreflective article with protected volume hologram was viewed using a retroviewer commercially available from 3M Company, Minnesota, USA, under the trade designation “3M™ Security Laminate Verifier. In retroreflected light, the volume hologram “M” was nearly invisible, and did not exhibit a three dimensional appearance.

While the invention has been illustrated and described in detail in the drawing and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below.

Furthermore, in the claims the word “comprising” does not exclude other elements or steps, and the indefinite article “a” or “an” does not exclude a plurality. A single unit may fulfill the functions of several features recited in the claims. The terms “essentially”, “about”, “approximately” and the like in connection with an attribute or a value particularly also define exactly the attribute or exactly the value, respectively. Any reference signs in the claims should not be construed as limiting the scope.

1. A security laminate, comprising:
protective layer;
a volume holographic layer; and
a prismatic retroreflective layer,
wherein the volume holographic layer is arranged between the protective layer and the prismatic retroreflective layer.

2. The security laminate according to claim 1, further comprising a support layer.

3. The security laminate according to claim 1, wherein the volume holographic layer is arranged between the support layer and the prismatic retroreflective layer

4. The security laminate according to claim 1, wherein the volume holographic layer is arranged between the support layer and the protective layer.

5. The security laminate according to claim 1, adapted such that to the unaided eye of an observer the volume holographic layer is perceptible through the protective layer under diffuse lighting conditions, and less perceptible under directed light through the protective layer onto the retroreflective layer.

6. The security laminate according to claim 1, further comprising a releasable liner at the rear side of the security laminate, and an adhesive layer, wherein the adhesive layer is arranged between the retroreflective layer and the releasable liner.

7. The security laminate of any according to claim 1, wherein the volume holographic layer faces with its front side towards the protective layer.

8. The security laminate according to claim 1, wherein the volume holographic layer is (1) a continuous sheeting, or (2) comprises at least one continuous volume holographic stripe, or (3) comprises at least one volume holographic patch.

9. An article comprising:
a security laminate according to claim 1; and
readable indicia located on the front side of the protective layer.

10. The article of claim 9, wherein the article is a license plate.

11. A method of making a security laminate, the method comprising the steps of:
a) providing a protective layer and a retroreflective layer;
b) applying a volume holographic layer onto the protective layer to form a security protective layer;
c) combining the security protective layer and the retroreflective layer to form a security laminate.

12. The method of claim 11, wherein the volume holographic layer is applied with its front side onto the protective layer.

13. The method of claim 11, wherein the retroreflective layer is a prismatic retroreflective layer.

14. The method of claim 13, further comprising the steps of providing a support layer, and casting the prismatic retroreflective layer onto the support layer.

15. The method of claim 11, comprising at least one of the steps of:
using the security laminate to form a license plate;
applying indicia onto the security laminate or the license plate;
providing a pressure sensitive adhesive between the volume holographic layer and the protective layer or the retroreflective layer.
